(19) United States
(12) Patent Application Publication
(10) Pub. No.: US 2025/0058501 A1
(43) Pub. Date: Feb. 20, 2025

(54) RUBBER SHEET

(71) Applicant: COMPAGNIE GENERALE DES ETABLISSEMENTS MICHELIN, Clermont-Ferrand (FR)

(72) Inventors: Scott FINEFROCK, Greenville, SC (US); Ruth Elizabeth GUERRA, Mauldin, SC (US); Robert Ciprian RADULESCU, Greenville, SC (US)

(21) Appl. No.: 18/723,121

(22) PCT Filed: Dec. 21, 2021
(86) PCT No.: PCT/US21/64518

§ 371 Date: Jun. 21, 2024

(51) Int. Cl. B29B 7/56; B29B 11/12; B29B 11/16; B29K 21/00; B29K 105/18; B29K 421/00

(52) U.S. Cl. CPC B29B 7/56; B29B 11/12; B29B 11/16; B29K 2021/00; B29K 2105/18; B29K 2421/00

(57) ABSTRACT

A rubber sheet allowing unexpectedly improved fatigue strength is made of a rubber composition based on at least an elastomer matrix and a crumb rubber comprising crumb rubber particles substantially perpendicularly oriented to a longitudinal direction of the rubber sheet.

### FIELD OF THE INVENTION

The subject matter of the present invention relates to a rubber sheet made of a rubber composition based on at least an elastomer matrix and a crumb rubber comprising crumb rubber particles substantially perpendicularly oriented to a longitudinal direction of the rubber sheet. In particular, the subject matter of the present invention relates to a rubber product comprising a rubber part including a rubber sheet made of a rubber composition based on at least an elastomer matrix and a crumb rubber comprising crumb rubber particles substantially perpendicularly oriented to a direction of strain expected to be applied to the rubber sheet of the rubber part during the use of the rubber product.

### BACKGROUND OF THE INVENTION

Addition of a crumb rubber to rubber compositions is a way to increase sustainable material content in rubber products (for example tires).

The addition of the crumb rubber included in the rubber compositions of the rubber products may cause the decrease in the tensile at break and the fatigue life, which are properties that comes with said addition of the crumb rubber.

WO2010039327 and WO2021123574 disclose rubber compositions with crumb rubbers and methods for producing rubber compositions with crumb rubbers, which make it possible to improve fatigue life of the rubber compositions.

A constant objective of manufacturers of the rubber products is further to improve the fatigue life.

### SUMMARY OF THE INVENTION

Aspects and advantages of the invention will be set forth in part in the following description, or may be obvious from the description, or may be learned through practice of the invention.

A first aspect of the invention is a rubber sheet made of a rubber composition based on at least an elastomer matrix and a crumb rubber comprising crumb rubber particles substantially perpendicularly oriented to the longitudinal direction of the rubber sheet.

The advantage of the invention is to improve the fatigue strength of the rubber sheet by the orientation of the crumb rubber particles.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a rubber sheet illustrating a method for orienting rubber particles substantially perpendicular to a longitudinal direction of the sheet, and the rubber particles substantially parallel to a vertical direction of the sheet.

FIG. 2 is a perspective view of a rubber sheet illustrating another method for orienting rubber particles substantially perpendicular to a longitudinal direction of the sheet, and the rubber particles substantially parallel to a vertical direction of the sheet.

FIG. 3 is a perspective view of a rubber sheet illustrating a method for orienting rubber particles substantially perpendicular to a longitudinal direction of the sheet, and the rubber particles substantially parallel to a lateral direction of the sheet.

FIG. 4 provides a X Ray Tomography image of a crumb rubber particle with the orientation of crumb rubber particle in a rubber sheet with a longitudinal direction of the rubber sheet.

The use of identical or similar reference numerals in different figures denotes identical or similar features.

### DETAILED DESCRIPTION OF THE INVENTION

The present invention provides a rubber sheet made of a rubber composition based on at least an elastomer matrix and a crumb rubber comprising crumb rubber particles substantially perpendicularly oriented to a longitudinal direction of the rubber sheet.

For purposes of describing the invention, reference now will be made in detail to embodiments and/or methods of the invention, one or more examples of which are illustrated in or with the drawings.

Each example is provided by way of explanation of the invention, not limitation of the invention.

In fact, it will be apparent to those skilled in the art that various modifications and variations can be made in the present invention without departing from the scope or spirit of the invention.

For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

As used herein, the term “based on” or “composition based on” should be understood as meaning a composition comprising the mixture, the product of the in situ reaction of the various base constituents used or both, some of these constituents being able to react, being intended to react, or being intended to react and being to react with one another, at least partially, during the various phases of manufacture of the composition or during the subsequent curing, modifying the composition as it is prepared at the start. Thus, the compositions as employed for the invention can be different in the non-crosslinked state and in the crosslinked (vulcanized) state.

As used herein, the terms “elastomer” and “rubber”, which are interchangeable, are used without distinction.

As used herein, the expression “elastomer matrix” is understood to mean, in a given composition, all of the elastomers present in said rubber composition.

As used herein, unless expressly stated otherwise, all the percentages (%) indicated are percentages by weight (wt %).

As used herein, unless expressly indicated otherwise, each Tg_{DSC} (glass transition temperature) is measured in a known way by DSC (Differential Scanning Calorimetry) according to Standard ASTM D3418-08.

When reference is made to a “predominant” compound, this is understood to mean, within the meaning of the present invention, that this compound is predominant among the compounds of the same type in the composition, that is to say that it is the one which represents the greatest amount by weight among the compounds of the same type, and preferably more than 50% by weight, more preferably more than 75% by weight. Thus, for example, a predominant polymer is the polymer representing the greatest weight, with respect to the total weight of the polymers in the composition. In the same way, a “predominant” filler is the one representing the greatest weight among the fillers of the composition. By way of example, in a system comprising just one polymer, the latter is predominant within the meaning of the present invention and, in a system comprising two polymers, the predominant polymer represents more than half of the weight of the polymers. On the contrary, a “minor” compound is a compound which does not represent the greatest fraction by weight among the compounds of the same type.

Within the meaning of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by weight among the units (or monomers) forming the compound (or polymer). Thus, for example, a resin predominantly composed of units resulting from C₅ monomers is a resin in which the C5 units represent the greatest amount by weight among all the units making up the said resin. In other words, a “predominant” monomer or an assembly of “predominant” monomers is a monomer (or an assembly of monomers) which represents the greatest fraction by weight in the polymer. On the contrary, a “minor” monomer is a monomer which does not represent the greatest molar fraction in the polymer.

The compounds mentioned in the description may be of fossil or biobased origin. In the latter case, they may partially or completely result from biomass or be obtained from renewable starting materials resulting from biomass. Polymers, plasticizers, fillers, and the like, are concerned in particular.

As used herein, the expression “A substantially perpendicularly oriented (or extending) to B” (or the expression “A substantially perpendicular to B” or the expression “A orienting (or extending) substantially perpendicularly to B”) means the angle from the orienting (or extending) direction of A (or A) to B is between 75 and 105 degrees, preferably within the range of from 80 to 100 degrees, more preferably within the range of from 85 to 95 degrees.

As used herein, the expression “A substantially parallelly oriented (or extending) to B” (or the expression “A substantially parallel to B” or the expression “A orienting (or extending) substantially parallelly to B”) means the angle from the orienting (or extending) direction of A (or A) to B is between −15 and 15 degrees, preferably within the range of from −10 to 10 degrees, more preferably within the range of from −5 to 5 degrees.

The rubber composition of the rubber sheet according to the invention is based on an elastomer matrix.

Elastomer (or loosely “rubber”, the two terms being regarded as synonyms) of the “diene” type is to be understood in a known manner as an (meaning one or more) elastomer derived at least partly (i.e. a homopolymer or a copolymer) from diene monomers (monomers bearing two carbon-carbon double bonds, conjugated or not).

These diene elastomers may be classified into two categories: “essentially unsaturated” or “essentially saturated”. Generally, the expression “essentially unsaturated” is understood to mean a diene elastomer resulting at least in part from conjugated diene monomers having a content of units of diene origin (conjugated dienes) which is more than 15% (mol %); thus it is that diene elastomers such as butyl rubbers or diene/α-olefin copolymers of the EPDM type do not fall under the preceding definition and may especially be described as “essentially saturated” diene elastomers (low or very low content of units of diene origin, always less than 15%). In the category of “essentially unsaturated” diene elastomers, the expression “highly unsaturated” diene elastomer is understood to mean in particular a diene elastomer having a content of units of diene origin (conjugated dienes) which is more than 50%.

Although it applies to any type of diene elastomer, it is preferably employed with essentially unsaturated diene elastomers.

Given these definitions, the expression diene elastomer capable of being used in the compositions in accordance with the invention is understood in particular to mean:
(a) any homopolymer obtained by polymerization of a conjugated diene monomer, preferably having within the range of from 4 to 12 carbon atoms;
(b) any copolymer obtained by copolymerization of one or more conjugated dienes with one another or with one or more vinyl aromatic compounds preferably having within the range of from 8 to 20 carbon atoms.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the“vinyltoluene” commercial mixture, para-(tert-butyl) styrene, methoxystyrenes, chlorostyrenes, vinylmesitylene, divinylbenzene or vinylnaphthalene.

A second aspect of the invention is the rubber sheet according to the first aspect, wherein the elastomer matrix comprises at least one elastomer selected from the group consisting of an isoprene elastomer and a butadiene elastomer.

As used herein, the isoprene elastomer is understood to mean all the elastomers predominantly composed of isoprene monomers.

According to a preferred embodiment of the second aspect, the isoprene elastomer is selected from the group consisting of isoprene polymers, isoprene copolymers and combinations thereof, preferably the isoprene elastomer consists of the isoprene polymers.

According to a more preferred embodiment of the above more preferred embodiment, the isoprene polymers are selected from the group consisting of natural rubber, synthetic polyisoprenes and combinations thereof, preferably the isoprene polymers consist of natural rubber.

According to a still more preferred embodiment of the above more preferred embodiment, the synthetic polyisoprene is a synthetic polyisoprene, preferably having a content (mol %) of cis-1,4 bonds of more than 90%, more preferably more than 95%, still more preferably more than 98%.

According to a more preferred embodiment of the above preferred embodiment, the isoprene copolymers are selected from the group consisting of butadiene isoprene copolymers (BIR), styrene isoprene copolymers (SIR), styrene butadiene isoprene copolymers (SBIR) and combinations thereof.

According to a still more preferred embodiment of the above more preferred embodiment, the butadiene isoprene copolymers (BIR) have an isoprene content of more than 50% by weight and less than 90% by weight per 100% by weight of the butadiene isoprene copolymers (BIR).

According to a still more preferred embodiment of the above more preferred embodiment, the styrene isoprene copolymers (SIR) have a Tg_{DSC} of more than −50° C. and less than −25° C.

According to a still more preferred embodiment of the above more preferred embodiment, the styrene butadiene isoprene copolymers (SBIR) have an isoprene content which is more than the styrene and butadiene content.

According to a still more preferred embodiment of the above more preferred embodiment, the styrene butadiene isoprene copolymers (SBIR) have an isoprene content of more than 50% by weight and less than 60% by weight per 100% by weight of the styrene butadiene isoprene copolymers (SBIR).

As used herein, the butadiene elastomer is understood to mean all the elastomers predominantly composed of butadiene monomers.

According to a preferred embodiment of the second aspect, the butadiene elastomer is selected from the group consisting of butadiene polymers, butadiene copolymers and combinations thereof, preferably selected from the group consisting of polybutadienes (BR), styrene butadiene copolymers (SBR) and combinations thereof, preferably selected from the group consisting of polybutadienes (BR) and combinations thereof.

According to a more preferred embodiment of the above preferred embodiment, the polybutadienes have a content (mol %) of 1,2-units of more than 4% and less than 80%.

According to a more preferred embodiment of the above preferred embodiment, the polybutadienes have a cis-1,4-content (mol %) of more than 80%

According to a more preferred embodiment of the above preferred embodiment aspect, the butadiene copolymer is selected from the group consisting of styrene butadiene copolymers (SBR), butadiene isoprene copolymers (BIR), styrene butadiene isoprene copolymers (SBIR) and combinations thereof, preferably selected from the group consisting of styrene butadiene copolymers (SBR) and combinations thereof.

According to a still more preferred embodiment of the above more preferred embodiment, the styrene butadiene copolymers (SBR) have a glass transition temperature Tg_{DSC} of more than −100° C. and less than 0° C., preferably more than −90° C. and less than 0° C., more preferably more than −80° C. and less than 0° C., still more preferably more than −70° C. and less than 0° C., particularly more than −60° C. and less than −10° C.

According to a still more preferred embodiment of the above more preferred embodiment, the styrene butadiene copolymers (SBR) have a content (mol %) of 1,2-bonds of the butadiene part of more than 4% and less than 75% and a content (mol %) of trans-1,4-bonds of more than 10% and less than 80%.

According to a still more preferred embodiment of the above more preferred embodiment, the styrene butadiene copolymers (SBR) have a content (mol %) of 1,2-bonds of the butadiene part of more than 4% and less than 75% and a content (mol %) of trans-1,4-bonds of more than 10% and less than 80%.

According to a still more preferred embodiment of the above more preferred embodiment, the butadiene copolymer is selected from the group consisting of butadiene isoprene copolymers (BIR) and combinations thereof.

According to a particular embodiment of the above still more preferred embodiment, the butadiene isoprene copolymers (BIR) have an isoprene content of more than 5% by weight and less than 50% by weight per 100% by weight of the butadiene isoprene copolymers (BIR).

According to a particular embodiment of the above still more preferred embodiment, the butadiene isoprene copolymers (BIR) have a Tg_{DSC} of within the range of from −80° C. to −40° C.

According to a still more preferred embodiment of the above more preferred embodiment, the butadiene copolymer is selected from the group consisting of styrene butadiene isoprene copolymers (SBIR) and combinations thereof. The styrene butadiene isoprene copolymers (SBIR) have a butadiene content which is more than the styrene and isoprene content.

According to a preferred embodiment of the second aspect, the total amount of the isoprene elastomer is more than 5 phr, preferably more than 10 phr, more preferably more than 15 phr, still more preferably more than 20 phr, particularly more than 25 phr, more particularly more than 30 phr, still more particularly more than 35 phr, advantageously more than 40 phr, more advantageously more than 45 phr, still more advantageously more than or equal to 50 phr.

According to a preferred embodiment of the second aspect, the total amount of the isoprene elastomer is less than 95 phr, preferably less than 90 phr, more preferably less than 85 phr, still more preferably less than 80 phr, particularly less than 75 phr, more particularly less than 70 phr, still more particularly less than 65 phr, advantageously less than 60 phr, more advantageously more than 55 phr, still more advantageously less than or equal to 50 phr.

According to a preferred embodiment of the second aspect, the total amount of the butadiene elastomer is more than 5 phr, preferably more than 10 phr, more preferably more than 15 phr, still more preferably more than 20 phr, particularly more than 25 phr, more particularly more than 30 phr, still more particularly more than 35 phr, advantageously more than 40 phr, more advantageously more than 45 phr, still more advantageously more than or equal to 50 phr.

According to a preferred embodiment of the second aspect, the total amount of the butadiene elastomer is less than 95 phr, preferably less than 90 phr, more preferably less than 85 phr, still more preferably less than 80 phr, particularly less than 75 phr, more particularly less than 70 phr, still more particularly less than 65 phr, advantageously less than 60 phr, more advantageously more than 55 phr, still more advantageously less than or equal to 50 phr.

According to a preferred embodiment of the second aspect, the elastomer matrix in the rubber composition of the rubber sheet according to the invention consists of the isoprene elastomer and the butadiene elastomer.

According to another preferred embodiment of the second aspect, the elastomer matrix in the rubber composition of the rubber sheet according to the invention comprises another elastomer or other elastomer than the isoprene elastomer and the butadiene elastomer.

Use may be made, as such, of any elastomer known to a person skilled in the art which is not defined above as isoprene elastomer or butadiene elastomer.

The rubber composition of the rubber sheet according to the invention is based on a crumb rubber comprising crumb rubber particles (abbreviated as “crumb” in the remainder of the description).

The crumb rubber particles are in the form of granules. Usually, crumb rubbers are derived from milling or micronization of cured rubber compositions already used for a first application, for example in tires; they are a product of the recycling of materials.

The crumb rubber may be obtained by reducing scrap tires or other rubbers into granules with reinforcing materials such as steels or fibers removed along with any other contaminants such as dusts, glasses or rocks. “Rubber Chemistry and Technology” discloses many methods of grinding vulcanized or crosslinked rubbers into crumb rubber.

According to a preferred embodiment of the invention, the crumb rubber is generated from scrap tires.

According to a preferred embodiment of the invention, the crumb rubber particles are in the form of microparticles.

As used herein, the term “microparticles” is intended to mean particles which have a particle size, namely their diameter in the case of spherical particles or their largest dimension in the case of anisometric particles, of a few microns or of a few tens microns or a few hundred microns.

A third aspect of the invention is the rubber sheet according to the first aspect or the second aspect, wherein the crumb rubber does not comprise any crumb rubber particles remaining on a 40 mesh sieve, or the crumb rubber comprises crumb rubber particles remaining on a 40 mesh sieve and the total amount of the crumb rubber particles remaining on the 40 mesh sieve is less than 10% by weight per 100% by weight of the crumb rubber, preferably wherein the crumb rubber does not comprise any crumb rubber particles remaining on a 60 mesh sieve, or the crumb rubber comprises crumb rubber particles remaining on a 60 mesh sieve and the total amount of the crumb rubber particles remaining on the 60 mesh sieve is less than 10% by weight per 100% by weight of the crumb rubber, more preferably wherein the crumb rubber does not comprise any crumb rubber particles remaining on a 80 mesh sieve, or the crumb rubber comprises crumb rubber particles remaining on a 80 mesh sieve and the total amount of the crumb rubber particles remaining on the 80 mesh sieve is less than 10% by weight per 100% by weight of the crumb rubber.

The total amount of the crumb rubber particles remaining on the 40 mesh sieve is less than 10% by weight per 100% by weight of the crumb rubber, which means more than 90% by weight of the crumb rubber particles per 100% by weight of the crumb rubber can pass though the 40 mesh sieve.

The total amount by weight of the crumb rubber particles in the crumb rubber of the rubber composition of the rubber sheet according to the invention may be obtained from the crumb particle size distribution determined in accordance with ASTM-D5644-01.

Alternatively, the crumb particle size distribution, that is the crumb particle size weight distribution, may be measured by laser particle size analysis, on a mastersizer 3000 device from Malvern. The measurement may be carried out by the liquid route, diluted in alcohol after an ultrasound pretreatment for 1 minute in order to guarantee the dispersion of the particles. The measurement may be carried out in accordance with standard ISO-13320-1 and may make it possible to determine in particular the D10 and the D50, that is to say the mean diameter below which respectively 10% by weight and 50% by weight of the total population of particles may be present.

According to a preferred embodiment of the invention, the crumb rubber particles have a mean size D50 of within the range of from 100 μm to 300 μm.

According to a preferred embodiment of the invention, the crumb rubber particles have a particle size distribution such that a means size ratio D10/D50 is more than or equal to 0.5, preferably more than or equal to 0.55, more preferably more than 0.55, still more preferably more than or equal to 0.6, particularly more than 0.6, more particularly more than or equal to 0.65, still more particularly more than 0.65.

According to a preferred embodiment of the invention, the crumb rubber particles have a particle size distribution such that a means size ratio D10/D50 is less than or equal to 1.0, preferably less than or equal to 0.95, more preferably less than 0.95, still more preferably less than or equal to 0.9, particularly less than 0.9, more particularly less than or equal to 0.85, still more particularly less than 0.85.

According to a preferred embodiment of the invention, the crumb rubber in the rubber composition of the rubber sheet according to the invention is mechanically processed, cryogenically processed, or mechanically and cryogenically processed, that is, the crumb rubber is ground using a mechanical grinding process, a cryogenic process or both processes. In both processes, the steel components are removed using a magnetic separator and the fiber components are separated by air classifiers or other separation equipment. The mechanical grinding process uses a variety of grinding techniques, such as cracker mills, granulators, etc. to mechanically break down the rubber into small particles. In the cryogenic process, shredded rubber is frozen at an extremely low temperature then shattered into small particles.

According to a more preferred embodiment of the above preferred embodiment, the crumb rubber is cryogenically processed in accordance with micronization processes as described in U.S. Pat. Nos. 7,445,170 and 7,861,958.

The crumb rubber commercially available is for example PolyDyne 40, PolyDyne 80, PolyDyne 140 or PolyDyne 200 from Lehigh Technologies.

A fourth aspect of the invention is the rubber sheet according to any one of the first to the third aspects, wherein the total amount of the crumb rubber is within the range of from 5 phr to 200 phr.

According to a preferred embodiment of the fourth aspect, the total amount of the crumb rubber in the rubber composition of the rubber sheet according to the invention is more than or equal to 10 phr, preferably more than or equal to 15 phr, more preferably more than or equal to 20 phr, still more preferably more than or equal to 25 phr, particularly more than or equal to 30 phr, more particularly more than or equal to 35 phr, still more particularly more than or equal to 40 phr, advantageously more than or equal to 45 phr, more advantageously more than or equal to 50 phr, still more advantageously more than or equal to 55 phr, especially more than or equal to 60 phr, more especially more than or equal to 70 phr, still more especially more than or equal to 75 phr, specially more than or equal to 80 phr.

According to a preferred embodiment of the fourth aspect, the total amount of the crumb rubber in the rubber composition of the rubber sheet according to the invention is less than or equal to 190 phr, preferably less than or equal to 180 phr, more preferably less than or equal to 170 phr, still more preferably less than or equal to 160 phr, particularly less than or equal to 150 phr, more particularly less than or equal to 140 phr, still more particularly less than or equal to 130 phr, advantageously less than or equal to 130 phr, more advantageously less than or equal to 120 phr, still more advantageously less than or equal to 110 phr, especially less than or equal to 100 phr, more especially less than or equal to 95 phr, still more especially less than or equal to 90 phr, specially less than or equal to 85 phr.

The crumb rubber in the rubber composition of the rubber sheet according to the invention may consist of a composition based on all ingredients normally used in rubber compositions for rubber products.

According to a preferred embodiment of the invention, the crumb rubber in the rubber composition of the rubber sheet according to the invention consists of a composition based on an elastomer.

According to a more preferred embodiment of the above preferred embodiment, the crumb rubber comprises an elastomer that represents more than 30% by weight, preferably more than 35% by weight, more preferably more than 40% by weight, per 100% by weight of the crumb rubber, said percentage determined in accordance with ASTM E1131-03.

According to a still preferred embodiment of the above preferred embodiment or the above more preferred embodiment, the crumb rubber comprises an elastomer that comprises, preferably consists of, a diene elastomer.

According to a particular embodiment of the above still more preferred embodiment, the diene elastomer in the crumb rubber is selected from the group consisting of polybutadienes, polyisoprenes including natural rubber, butadiene copolymers and isoprene copolymers.

According to a particular embodiment of the above still more preferred embodiment, the molar content of units of diene origin (conjugated dienes) presents the diene elastomer in the crumb rubber is more than 50%, preferably more than 50% and less than 70%.

According to a preferred embodiment of the invention, the crumb rubber in the rubber composition of the rubber sheet according to the invention consists of a composition based on a filler.

According to a more preferred embodiment of the above preferred embodiment, the above amount of the filler in the crumb rubber is more than 5% by weight and less than 80% by weight, preferably more than 10% by weight and less than 75% by weight, more preferably more than 15% by weight and less than 70% by weight, of a filler per 100% by weight of the crumb rubber, said percentage being determined in accordance with ASTM E1131-03.

The term “filler” is intended to mean herein any type of filler, whether reinforcing filler (typically having nanometric particles, with a weight-average size preferably of less than 500 nm, in particular more than 20 nm and less than 200 nm) or non-reinforcing filler or inert filler (typically having micrometric particles, with a weight-average size preferably of more than 1 μm, for example more than 2 μm and less than 200 μm). The weight-average size of the nanometric particles is measured in a manner well known to those skilled in the art (by way of example, according to patent application WO 2009/083160 paragraph 1.1). The weight-average size of the micrometric particles may be determined by mechanical screening.

According to a more preferred embodiment of the above preferred embodiment, the filler in the crumb rubber comprises a reinforcing filler, preferably the reinforcing filler comprises a reinforcing organic filler, a reinforcing inorganic filler or a combination thereof.

Use may be made of any type of reinforcing filler known for its capabilities of reinforcing a rubber composition which can be used for the manufacture of the rubber product, for example a reinforcing organic filler, such as at least one carbon black, or a reinforcing inorganic filler, such as a silica (SiO₂), an alumina (Al₂O₃) or a combination thereof, with which at least one coupling agent is combined in a known way.

According to a still more preferred embodiment of the above more preferred embodiment, the reinforcing filler in the crumb rubber comprises a reinforcing organic filler, preferably at least one carbon black, more preferably representing more than 50% by weight, still more preferably more than 60% by weight, particularly more than 70% by weight, more particularly more than 80% by weight, still more particularly more than 90% by weight, advantageously 100% by weight, per 100% by weight of the reinforcing filler.

According to a still more preferred embodiment of the above more preferred embodiment, the reinforcing filler in the crumb rubber comprises a reinforcing organic filler, preferably at least one carbon black, more preferably representing within the range of from 20% by weight to 40% by weight, still more preferably within the range of from 25% by weight to 35% by weight, per 100% by weight of the crumb rubber.

The carbon black weight fraction may be measured by thermogravimetric analysis (TGA) in accordance with standard NF T-46-07, on an instrument from the company Mettler Toledo, model “TGA/DSC1”. Approximately 20 g of sample may be introduced into the thermal analyzer, then subjected to a thermal program within the range of from 25° C. to 600° C. under an inert atmosphere (pyrolysable phase), then within the rage of from 400° C. to 750° C. under an oxidizing atmosphere (oxidizable phase). The weight of the sample may be measured continuously throughout the thermal program. The organic matter content may correspond to the loss of weight measured during the pyrolysable phase related back to the initial weight of sample. The amount of carbon black may correspond to the loss of weight measured during the oxidizable phase related back to the initial weight of sample.

As carbon blacks, all carbon blacks, in particular blacks of the SAF, ISAF, HAF, FEF, GPF, HMF, SRF, and SRF type, conventionally used in tires (“tire-grade” blacks) are suitable, such as for example reinforcing carbon blacks of the 100, 200 or 300 series in ASTM grades (such as for example, the N115, N134, N234, N326, N330, N339, N347 or N375 blacks), or carbon blacks higher series, the 500, 600, 700, 800 or 900 series in ASTM grades (such as for example the N550, N660, N683, N772, N774, N880, N990, N991 blacks).

According to a more preferred embodiment of the above preferred embodiment, the filler in the crumb rubber comprises a non-reinforcing filler, preferably chalk, kaolin or a combination thereof.

The crumb rubber in the rubber composition of the rubber sheet according to the invention may consist of a composition based on usual additives generally used in the rubber compositions intended for rubber products or rubber parts for rubber products. The additives may also be in the crumb rubber in the form of a residue or of a derivative, since they were able to react during the steps of producing the composition or of crosslinking the composition from which the crumb rubber is derived.

The crumb rubber in the rubber composition of the rubber sheet according to the invention may be simple ground/micronized rubber materials, without any other treatment.

A fifth aspect of the invention is the rubber sheet according to any one of the first to the fourth aspects, wherein the crumb rubber has not undergone any modification by a treatment selected from the group consisting of thermal, mechanical, biological, and chemical treatments and combinations thereof.

According to a preferred embodiment of the fifth aspect, the crumb rubber has an acetone extract of more than 3% by weight and less than 30% by weight, preferably more than 3% by weight and less than 15% by weight, more preferably more than 3% by weight and less than 10% by weight, per 100% by weight of the crumb rubber.

According to a preferred embodiment of the fifth aspect, the crumb rubber has a chloroform extract of more than 3% by weight and less than 85% by weight, preferably more than 3% by weight and less than 20% by weight, more preferably less than 5% by weight and less than 15% by weight, by weight per 100% by weight of the crumb rubber.

According to a preferred embodiment of the fifth aspect, the crumb rubber has a chloroform extract of which the weight-average molecular weight (Mw) is less than 10000 g/mol, preferably less than 8000 g/mol.

According to a preferred embodiment of the fifth aspect, a ratio by weight of a chloroform extract to an acetone extract in the crumb rubber is less than 1.5.

According to an embodiment of the invention, the crumb rubber in the rubber composition of the rubber sheet according to the invention undergoes a treatment in order to modify them. This treatment can consist of a chemical functionalization or devulcanization modification. It can also be a thermomechanical, thermochemical, biological, and the like, treatment.

According to an embodiment of the invention, the crumb rubber in the rubber composition of the rubber sheet according to the invention has a morphology modified by heat treatment, mechanical treatment, biological treatment, chemical treatment or a combination thereof. Preferably, the modified crumb rubber has an acetone extract of more than 5% by weight and less than 20% by weight, more preferably within the range of from 10% by weight to 18% by weight. Likewise, preferably, the modified crumb rubber has a chloroform extract of more than 15% by weight and less than 85% by weight, more preferably within the range of from 15% by weight to 50% by weight. Preferably, the chloroform extract of the modified crumb rubber has a weight-average molecular weight (Mw) of more than 10000 g/mol, more preferably of more than 20000 g/mol and still more preferably of more than 30000 g/mol. Preferably, a ratio by weight of the chloroform extract to the acetone extract in the modified crumb rubber is more than or equal to 1.5, preferably more than 2.

The amount of acetone extract or chloroform extract may be measured according to Standard ISO1407 by means of an extractor of Soxhlet type. A test sample (more than 500 mg and less than 5 g) may be introduced into an extraction chamber and then placed in the extractor tube of the Soxhlet. A volume of acetone or chloroform equal to two or three times of the volume of the extractor tube may be placed in the collector of the Soxhlet. The Soxhlet may be subsequently assembled and then heated for 16 h. The sample may be weighed after extraction. The amount of acetone extract or chloroform extract may correspond to the loss in weight of the sample during the extraction, with respect to its initial weight.

The molecular weights may be determined by size exclusion chromatography, according to a Moore calibration and in accordance with Standard ISO16014. The weight-average molecular weight (Mw) of the chloroform extract may be measured by size exclusion chromatography (SEC) with a refractive index (RI) detector. The system may be composed of an Alliance 2695 line from Waters, of a column oven from Waters and also of an RI 410 detector from Waters. The set of columns used may be composed of two PL Gel Mixed D columns (300×7.5 mm 5 μm), followed by two PL Gel Mixed E columns (300×7.5 mm 3 μm) from Agilent. These columns may be placed in a column oven thermostatically controlled at 35° C. The mobile phase used may be non-antioxidized tetrahydrofuran. The flow rate of the mobile phase may be 1 ml/minute. The RI detector may be also thermostatically controlled at 35° C. The chloroform extract may be dried under a nitrogen stream. The dry extract may be subsequently taken up at 1 g/l in non-antioxidized tetrahydrofuran at 250 ppm with stirring for 2 hours. The solution obtained may be filtered using a syringe and a single-use 0.45 μm PTFE syringe filter. 100 μl of the filtered solution may be injected into the conditioned chromatographic system at 1 ml/minute and 35° C. The Mw results may be provided by integration of the chromatographic peaks detected by the RI detector above a value of 2000 g/mol. The Mw may be calculated from a calibration carried out using polystyrene standards.

The rubber compositions of the rubber sheets according to the invention may be based on all or at least one portion of the usual additives generally used in the rubber compositions intended for rubber products or rubber parts for rubber products, such as fillers other than crumb rubbers (for example, reinforcing fillers, reinforcing organic fillers (for example, carbon blacks), reinforcing inorganic fillers (for example, silicas) or combinations thereof, coupling agents, plasticizing agents (for example, liquid plasticizers (for example, oils), solid plasticizers (for example, hydrocarbon resins having or not having characters of tackifying resins) or combinations thereof), protection agents (for example, anti-ozone waxes, chemical antiozonants, antioxidants or combinations thereof), pigments, anti-fatigue agents, reinforcing resins, methylene acceptors (for example phenolic novolak resin), methylene donors (for example, hexamethylenetetramine (HMT), hexamethoxymethylmelamine (H3M) or a combination thereof), processing aids, processing acids, a crosslinking (vulcanization) system or a combination thereof.

A sixth aspect of the invention is the rubber sheet according to any one of the first to the fifth aspects, wherein the rubber composition is further based on a reinforcing filler.

Use may be made of any type of reinforcing filler known for its capabilities of reinforcing a rubber composition which can be used for the manufacture of the rubber product, for example a reinforcing organic filler, such as at least one carbon black, or a reinforcing inorganic filler, such as a silica (SiO₂), an alumina (Al₂O₃) or a combination thereof, with which at least one coupling agent is combined in a known way.

According to a preferred embodiment of the sixth aspect, the reinforcing filler in the rubber composition of the rubber sheet according to the invention comprises a reinforcing organic filler, preferably at least one carbon black, more preferably representing more than 50% by weight, still more preferably more than 60% by weight, particularly more than 70% by weight, more particularly more than 80% by weight, still more particularly more than 90% by weight, advantageously 100% by weight, per 100% by weight of the reinforcing filler.

The carbon black weight fraction may be measured by thermogravimetric analysis (TGA) in accordance with standard NF T-46-07, on an instrument from the company Mettler Toledo, model “TGA/DSC1”. Approximately 20 g of sample may be introduced into the thermal analyzer, then subjected to a thermal program within the rage of from 25° C. to 600° C. under an inert atmosphere (pyrolysable phase), then within the range of from 400° C. to 750° C. under an oxidizing atmosphere (oxidizable phase). The weight of the sample may be measured continuously throughout the thermal program. The organic matter content may correspond to the loss of weight measured during the pyrolysable phase related back to the initial weight of sample. The amount of carbon black may correspond to the loss of weight measured during the oxidizable phase related back to the initial weight of sample.

As carbon blacks, all carbon blacks, in particular blacks of the SAF, ISAF, HAF, FEF, GPF, HMF, SRF, and SRF type, conventionally used in tires (“tire-grade” blacks) are suitable, such as for example reinforcing carbon blacks of the 100, 200 or 300 series in ASTM grades (such as for example, the N115, N134, N234, N326, N330, N339, N347 or N375 blacks), or carbon blacks higher series, the 500, 600, 700, 800 or 900 series in ASTM grades (such as for example the N550, N660, N683, N772, N774, N880, N990, N991 blacks).

According to a preferred embodiment of the sixth aspect, the reinforcing filler comprises a carbon black.

According to a more preferred embodiment of the above preferred embodiment, the carbon black exhibits a BET surface area (in accordance with ASTM D6556-10) of more than 50 m²/g (for example, between 50 and 140 m²/g), preferably more than 55 m²/g (for example, between 55 and 125 m²/g), more preferably more than 60 m²/g (for example, between 60 and 110 m²/g), still more preferably more than 65 m²/g (for example, between 65 and 95 m²/g), particularly at least 70 m²/g (for example, from 70 to 80 m²/g).

According to a more preferred embodiment of the above preferred embodiment, the carbon black exhibits an oil absorption number of compressed Sample (COAN: compressed oil absorption number) (in accordance with ASTM D3493-16) of more than 40 ml/100 g (for example, between 40 and 120 ml/100 g), preferably more than 50 ml/100 g (for example, between 50 and 115 ml/100 g), more preferably more than 60 ml/100 g (for example, between 60 and 110 ml/100 g), still more preferably more than 70 ml/100 g (for example, between 70 and 105 ml/100 g), particularly at least 80 ml/100 g (for example, 80 to 100 ml/100 g).

According to a preferred embodiment of the sixth aspect, the total amount of the reinforcing filler in the rubber composition of the rubber sheet according to the invention is within the range of from 5 phr to 200 phr.

According to a more preferred embodiment of the above preferred embodiment, the total amount of the reinforcing filler in the rubber composition of the rubber sheet according to the invention is more than or equal to 10 phr, preferably more than or equal to 15 phr, more preferably more than or equal to 20 phr, still more preferably more than or equal to 25 phr, particularly more than or equal to 30 phr, more particularly more than or equal to 35 phr, still more particularly more than or equal to 40 phr, advantageously more than or equal to 45 phr, more advantageously more than or equal to 50 phr, still more advantageously more than or equal to 55 phr.

According to a more preferred embodiment of the above preferred embodiment, the total amount of the reinforcing filler in the rubber composition of the rubber sheet according to the invention is less than or equal to 190 phr, preferably less than or equal to 180 phr, more preferably less than or equal to 170 phr, still more preferably less than or equal to 160 phr, particularly less than or equal to 150 phr, more particularly less than or equal to 140 phr, still more particularly less than or equal to 130 phr, advantageously less than or equal to 120 phr, more advantageously less than or equal to 110 phr, still more advantageously less than or equal to 100 phr, especially less than or equal to 90 phr, more especially less than or equal to 80 phr, still more especially less than or equal to 70 phr, specially less than or equal to 60 phr.

A seventh aspect of the invention is the rubber sheet according to any one of the first to the sixth aspects, wherein the rubber composition is further based on a plasticizing agent.

According to a preferred embodiment of the seventh aspect, the plasticizing agent in the rubber composition of the rubber sheet according to the invention is selected from the group consisting of liquid plasticizing agents, hydrocarbon resins and combinations thereof.

Any extending oil, whether of aromatic or non-aromatic nature, any liquid plasticizing agent known for its plasticizing properties with regard to the elastomer matrix, for instance, diene elastomers, can be used as the liquid plasticizers to soften the matrix by diluting the elastomer and the reinforcing filler. At ambient temperature (20° C.) under atmospheric pressure, these plasticizers or these oils, which are more or less viscous, are liquids (that is to say, as a reminder, substances that have the ability to eventually take on the shape of their container), as opposite to plasticizing hydrocarbon resins which are by nature solid at ambient temperature (20° C.) under atmospheric pressure.

According to a more preferred embodiment of the above preferred embodiment, the liquid plasticizers are selected from the group consisting of liquid diene polymers, polyolefinic oils, naphthenic oils, paraffinic oils, Distillate Aromatic Extracts (DAE) oils, Medium Extracted Solvates (MES) oils, Treated Distillate Aromatic Extracts (TDAE) oils, Residual Aromatic Extracts (RAE) oils, Treated Residual Aromatic Extracts (TRAE) oils, Safety Residual Aromatic Extracts (SRAE) oils, mineral oils, vegetable oils, ether plasticizers, ester plasticizers, phosphate plasticizers, sulfonate plasticizers and combinations thereof.

The hydrocarbon resins are polymer well known by a person skilled in the art, which are essentially based on carbon and hydrogen, and thus miscible by nature in rubber compositions, for instance, diene elastomer compositions. They can be aliphatic or aromatic or also of the aliphatic/aromatic type, that is to say based on aliphatic, aromatic or both monomers. They can be natural or synthetic and may or may not be petroleum-based (if such is the case, also known under the name of petroleum resins). They are preferably exclusively hydrocarbon, that is to say, that they comprise only carbon and hydrogen atoms.

Preferably, the hydrocarbon resins as being “plasticizing” exhibit at least one, more preferably all, of the following characteristics:
a Tg_{DSC} of more than 20° C. (for example, between 20° C. and 400° C.), preferably more than 30° C. (for example, between 30° C. and 300° C.), more preferably more than 40° C. (for example, between 40° C. and 200° C.);
a number-average molecular weight (Mn) of between 400 and 2000 g/mol (more preferably between 500 and 1500 g/mol);
a polydispersity index (PI) of less than 3, more preferably less than 2 (reminder: PI=Mw/Mn with Mw the weight-average molecular weight).

The macrostructure (Mw, Mn and PI) of the hydrocarbon resins is determined by steric exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

According to a more preferred embodiment of the above preferred embodiment, the hydrocarbon resins are selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, alpha-methyl styrene homopolymer or copolymer resins and combinations thereof. Use is more preferably made, among the above copolymer resins, of those selected from the group consisting of (D)CPD/vinylaromatic copolymer resins, (D)CPD/terpene copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins, C₉ fraction/vinylaromatic copolymer resins, and combinations thereof.

The term “terpene” combines here, in a known way, the α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, the racemate of the dextrorotatory and laevorotatory enantiomers. Styrene, α-methylstyrene, ortho-, meta- or para-methylstyrene, vinyltoluene, para-(tert-butyl)styrene, methoxystyrenes, chlorostyrenes, hydroxystyrenes vinylmesitylene, divinylbenzene, vinylnaphthalene, or any vinylaromatic monomer resulting from a C₉ fraction (or more generally from a C₈ to C₁₀ fraction) are suitable, for example, as vinylaromatic monomer. Preferably, the vinylaromatic compound is styrene or a vinylaromatic monomer resulting from a C₉ fraction (or more generally from a C₈ to C₁₀ fraction). Preferably, the vinylaromatic compound is the minor monomer, expressed as molar fraction, in the copolymer under consideration.

The preferred resins above are well known to a person skilled in the art and are commercially available, for example:
polylimonene resins: by DRT under the name “Dercolyte L120” (Mn=625 g/mol; Mw=1010 g/mol; PI=1.6; TgDSC=72° C.) or by Arizona Chemical Company under the name “Sylvagum TR7125C” (Mn=630 g/mol; Mw=950 g/mol; PI=1.5; TgDSC=70° C.);
C₅ fraction/vinylaromatic, notably C₅ fraction/styrene or C₅ fraction/C₉ fraction, copolymer resins: by Neville Chemical Company under the names “Super Nevtac 78”, “Super Nevtac 85” or “Super Nevtac 99”, by Goodyear Chemicals under the name “Wingtack Extra”, by Kolon under the names “Hikorez T1095” and “Hikorez T1100”, or by Exxon under the names “Escorez 2101” and “ECR 373”;
limonene/styrene copolymer resins: by DRT under the name “Dercolyte TS 105” or by Arizona Chemical Company under the names “ZT115LT” and “ZT5100”.

Mention may also be made, as examples of other preferred resins, of phenol-modified α-methylstirene resins. It should be remembered that, in order to characterize these phenol-modified resins, use is made, in a known way, of a number referred to as “hydroxyl number” (measured according to Standard ISO 4326 and expressed in mg KOH/g). α-Methylstirene resins, in particular those modified with phenol, are well known to a person skilled in the art and are available commercially, for example sold by Arizona Chemical Company under the names “Sylvares SA 100” (Mn=660 g/mol; PI=1.5; Tg_{DSC}=53° C.); “Sylvares SA 120” (Mn=1030 g/mol; PI=1.9; Tg_{DSC}=64° C.); “Sylvares 540” (Mn=620 g/mol; PI=1.3; Tg_{DSC}=36° C.; hydroxyl number=56 mg KOH/g); and “Sylvares 600” (Mn=850 g/mol; PI=1.4; Tg_{DSC}=50° C.; hydroxyl number=31 mg KOH/g).

An eighth aspect of the invention is the rubber sheet according to any one of the first to the seventh aspects, wherein the rubber composition is further based on a crosslinking system.

According to a preferred embodiment of the eighth aspect, the crosslinking system in the rubber composition of the rubber sheet according to the invention comprises a vulcanization agent, preferably selected from the group consisting of sulfur (sulphur), a sulfur donor, a peroxide, a bismaleimide and a combination thereof, more preferably selected from the group consisting of sulfur and a combination thereof. The vulcanization agent is called “vulcanizing agent”, “curative” or “curing agent”. According to a more preferred embodiment of the above preferred embodiment, the sulfur donner is alkylphenol disulfide (abbreviated as “APDS”), more preferably para-(tert butyl) phenol disulfide. According to a more preferred embodiment of the above preferred embodiment, the total amount of vulcanization agent is more than 0.5 phr and less than 10 phr, preferably more than 0.5 phr and less than 3 phr.

According to a preferred embodiment of the eighth aspect, the crosslinking system in the rubber composition of the rubber sheet according to the invention comprises a vulcanization accelerator, preferably a primary vulcanization accelerator, more preferably selected from the group consisting of an accelerator of sulfenamide type, an accelerator of thiazole type, an accelerator of thiuram type, an accelerator of dithiocarbamate type and a combination thereof, more preferably selected from the group consisting of an accelerator of sulfenamide type and a combination thereof. According to a more preferred embodiment of the above preferred embodiment, the accelerator of sulfenamide type is selected from the group consisting of N-Cyclohexyl-2-benzothiazolesulfenamide (abbreviated as “CBS”), N-(tert-Butyl)-2-benzothiazolesulfenamide (abbreviated as “TBBS”), N-tert-Butyl-2-benzothiazolesulfenimide (abbreviated as “TBSI”), N-Oxydiethylene-2-benzothiazolesulfenamide (abbreviated as “MBS”), N,N′-dicyclohexyl-2-benzothiazolesulfenamide (abbreviated as “DCBS”) and a combination thereof. According to a more preferred embodiment of the above preferred embodiment, the accelerator of thiazole type is selected from the group consisting of 2-mercaptobenzothiazole (abbreviated as “MBT”), 2-mercaptobenzothiazyl disulfide (abbreviated as “MBTS”), Zinc-2-mercaptobenzothiazole (abbreviated as “ZMBT”), 2-(Morpholinothio)benzothiazole (abbreviated as “MDB”) and a combination thereof. According to a more preferred embodiment of the above preferred embodiment, the accelerator of thiuram type is selected from the group consisting of Tetramethylthiuram Disulfide (abbreviated as “TMTD”), Tetraethylthiuram Disulfide (abbreviated as “TETD”), Tetrabutylthiuram disulfide (abbreviated as “TBTD”), Tetrakis(2-ethylhexyl) thiuram disulfide (abbreviated as “TOT-N”), Tetramethylthiuram Monosulfide (abbreviated as “TMTM”), Dipentamethylenethiuram Tetrasulfide (abbreviated as “DPTT”), Tetrabenzylthiuram Disulfide (abbreviated as “TBzTD”) and a combination thereof. According to a more preferred embodiment of the above preferred embodiment, the accelerator of dithiocarbamate type is selected from the group consisting of Zinc Dimethyldithiocarbamate (abbreviated as “ZDMC”), Zinc Diethyldithiocarbamate (abbreviated as “ZDEC”), Zinc Dibutyldithiocarbamate (abbreviated as “ZDBC”), Zinc Ethylphenyldithiocarbamate (abbreviated as “ZEPC”), Zinc Dibenzyldithiocarbamate (abbreviated as “ZDBzC”), Zinc N-pentamethylenedithiocarbamate (abbreviated as “ZPDC”) and a combination thereof. According to a more preferred embodiment of the above preferred embodiment, the total amount of the vulcanization accelerator is more than 0.5 phr and less than 5.0 phr.

According to a preferred embodiment of the eighth aspect, the crosslinking system in the rubber composition of the rubber sheet according to the invention comprises a vulcanization retarder, for example N-cyclohexylthiophthalimide (abbreviated as “CTP”).

According to a preferred embodiment of the eighth aspect, the crosslinking system in the rubber composition of the rubber sheet according to the invention comprises a vulcanization activator, preferably selected from the group consisting of zinc oxide, fatty acid, zinc fatty acid ester, a guanidine derivative or a combination thereof. According to a more preferred embodiment of the above preferred embodiment, the fatty acid is stearic acid, lauric acid, palmitic acid, oleic acid, naphthenic acid or a combination thereof. According to a more preferred embodiment of the above preferred embodiment, the zinc fatty acid ester is zinc stearic acid, zinc lauric acid, zinc palmitic acid, zinc oleic acid, zinc naphthenic acid or a combination thereof. According to a more preferred embodiment of the above preferred embodiment, the guanidine derivative is diphenylguanidine.

The rubber sheets according to the invention may be used alone or as a combination with any other rubber sheet which can be used for the manufacture of rubber parts, rubber product or both.

It goes without saying that the invention relates to the rubber compositions of the rubber sheets described previously both in the uncured state or non-crosslinked state or also raw state (i.e., before curing) and in the cured state or crosslinked state or also vulcanized, state (i.e., after crosslinking or vulcanization).

According to a preferred embodiment of the invention, the rubber composition of the rubber sheet according to the invention is further based on a crosslinking system comprising a vulcanization agent, a vulcanization accelerator, a vulcanization retarder, a vulcanization activator or a combination thereof, and the rubber composition of the rubber sheet according to the invention is manufactured in a mixer using two successive preparation phases: a first phase of thermomechanical working or kneading (referred to as “non-productive” phase) at high temperature, up to a maximum temperature of more than 110° C. and less than 200° C., preferably more than 110° C. and less than 190° C., more preferably more than 130° C. and less than 180° C., followed by a second phase of mechanical working (referred to as “productive” phase) at a lower temperature of less than or equal to 110° C., preferably more than 40° C. and less than 100° C., more preferably more than 60° C. and less than 100° C., finishing phase during which the vulcanization agent, the vulcanization accelerator and the vulcanization retarder or the combination thereof in the crosslinking system is incorporated. According to a more preferred embedment of the above preferred embodiment, the vulcanization activator is incorporated during the first non-productive phase, during the productive phase or during both of the phases, preferably during the first non-productive phase.

According to a more preferred embodiment of the above preferred embodiment, the first phase (the non-productive phase) is performed in several thermomechanical steps: during the first step in the in several thermomechanical steps, the elastomer matrix, the crumb rubber (and optionally other ingredients or combinations thereof, with the exception of the vulcanization agent, the vulcanization accelerator, the vulcanization retarder or the combination thereof in the crosslinking system) are introduced into a mixer (preferably an internal mixer) at a temperature of more than 20° C. and less than 100° C., preferably more than 25° C. and less than 100° C.; and after a few minutes, preferably within the range of from 0.5 minutes to 2 minutes, and a rise in the temperature equal to 90° C. or more (preferably, 100° C.), the elastomer matrix, the other ingredient and the combination thereof (that is to say, those which remain, if not all were introduced into the mixer in the first step (the non-productive phase)) are added all at once or portionwise, with the exception of the vulcanization agent, the vulcanization accelerator, the vulcanization retarder or the combination thereof in the crosslinking system, during a compounding ranging from 20 seconds to a few minutes; wherein the total duration of the kneading, in the first phase (the non-productive phase), is preferably more than 1 minute and less than 15 minutes, more preferably more than 2 minutes and less than 10 minutes, at a temperature of less than or equal to 190° C., preferably less than or equal to 180° C., more preferably of less than or equal to 170° C.

According to a still more preferred embodiment of the above preferred embodiment or the above more preferred embodiment, after cooling of the mixture thus obtained, the vulcanization agent, the vulcanization accelerator, the vulcanization retarder or the combination thereof in the crosslinking system is then incorporated at low temperature, preferably of less than or equal to 100° C., more preferably less than or equal to 90° C., in an external mixer, preferably an open mill; the whole is then mixed in the second phase (the productive phase) for a few minutes, preferably more than 2 minutes and less than 15 minutes, more preferably more than 5 minutes and less than 15 minutes.

According to another preferred embodiment of the invention, the rubber composition of the rubber sheet according to the invention is manufactured in a mixer using one preparation phase

The rubber composition of the rubber sheet according to the invention may be thus obtained in such the above mixer using two successive preparation phases, and the rubber sheet according to the invention may be produced by subsequently calendering, extruding or both the rubber composition of the rubber sheet according to the invention.

The rubber sheet according to the invention may be in the form of a rubber plaque for laboratory characterization or a rubber profile element able to be used directly as a rubber part for a rubber product.

The crumb rubber particles in the crumb rubber of the rubber composition of the rubber sheet according to the invention is substantially perpendicularly oriented to a longitudinal direction of the rubber sheet according to the invention.

The longitudinal direction of the rubber sheet according to the invention is a direction of a long axis of the rubber sheet according to the invention.

The rubber sheet according to the invention has the longitudinal direction substantially perpendicular to the orientations of the crumb rubber particles, which means the crumb rubber particles have long axes substantially perpendicular to the longitudinal direction of the rubber sheet according to the invention. In the other words, the long axes of crumb rubber particles are substantially perpendicular to the long axis of the axis of the rubber sheet.

According to a preferred embodiment, the crumb rubber particles in the rubber sheet according to the invention are anisotropic particles.

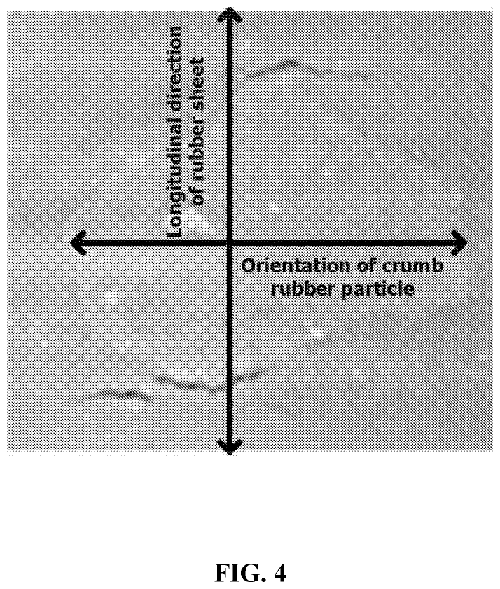

The orientations of the crumb rubber particles in the rubber sheet according to the invention may be measured by electron microscopy (for example, scanning electron microscope (SEM)) or X-ray tomography as shown in FIG. 4. In case of using X-ray tomography, the three dimensional images of the crumb rubber particles are obtained from X-ray tomography, vectors (or in other words, lengths) of each of the three axes of the crumb rubber particles (one axis along the longitudinal direction of the rubber sheet and two axes perpendicular to the longitudinal direction of the rubber sheet) are calculated from the three-dimensional images with a software (for example, ImageJ: a Java-based image processing program developed at the National Institutes of Health and the Laboratory for Optical and Computational Instrumentation (LOCI, University of Wisconsin)). The number of the crumb rubber particles measured is preferably more than or equal to 30.

According to an embodiment of the invention, the crumb rubber in rubber sheet according to the invention mainly comprises crumb rubber particles substantially perpendicularly oriented to a longitudinal direction of the rubber sheet, that is, the crumb rubber in the rubber sheet according to the invention is free of another crumb rubber particle not substantially perpendicularly oriented to the longitudinal direction of the rubber sheet, or the crumb rubber in the rubber sheet according to the invention comprises other crumb rubber particles not substantially perpendicularly oriented to the longitudinal direction of the rubber sheet, and the number of the crumb rubber particles substantially perpendicularly oriented to the longitudinal direction of the rubber sheet is more than that of the other rubber particles not substantially perpendicularly oriented to the longitudinal direction of the rubber sheet, preferably the number of the crumb rubber particles substantially perpendicularly oriented to the longitudinal direction of the rubber sheet is more than 1.1 times, more preferably more than 1.2 times, still more preferably more than 1.3 times, particularly more than 1.4 times, more particularly more than or equal to 1.5 times, of the number of the other rubber particles not substantially perpendicularly oriented to the longitudinal direction of the rubber sheet.

A ninth aspect of the invention is the rubber sheet according to any one of the first to the eighth aspects, wherein the rubber sheet according to the invention has a length in the longitudinal direction, a width in a lateral direction and a thickness in a vertical direction, wherein the length is longer than the width, wherein the width is longer than the thickness, wherein the longitudinal direction is perpendicular to the lateral direction and the vertical direction, wherein the lateral direction is perpendicular to the vertical direction, and wherein the crumb rubber particles are further substantially parallelly oriented to the lateral direction or the vertical direction.

A tenth aspect of the invention is the rubber sheet according to any one of the first to the ninth aspects, wherein the rubber sheet is produced by a method comprising at least:
a step of feeding the rubber composition into a roller process having a plural of rolls having a rotation axle with an axial direction (Y);
   a step of discharging a discharged rubber layer made of the rubber composition from the roll process in a discharge direction (X) which is perpendicular to the axial direction (Y) and which is perpendicular to another direction (Z) perpendicular to the axial direction (Y);
wherein the method further comprises:
   a step of repeatedly folding the discharged rubber layer in a direction substantially parallel to the other direction (Z), preferably furthermore comprises a step of excluding the top surface and the bottom zones including the folded end points;
or
wherein the method further comprises:
   a step of stacking a plural of the discharged rubber layers or not stacking; and
   a step of cutting the discharged rubber layer or the plural of the discharged rubber layers into sections substantially perpendicular to the discharge direction (X);
   a step of rotating the normal direction of the cut sections to a direction substantially parallel to the axial direction (Y) or the other direction (Z); and
   a step of bonding the rotated sections together at a seam.

The above method in the tenth aspect may make the orientations of the crumb rubber particles substantially perpendicular to the longitudinal direction of the rubber sheet because the crumb rubber particles can be substantially parallelly oriented to the discharge direction (X) on the step of discharging the discharged rubber layer.

The normal directions of the bonded sections after the step of bonding the rotated sections together at the seam are substantially parallel to longitudinal direction of the rubber sheet and are substantially perpendicular to the orientations of the crumb rubber particles.

In the tenth aspect, the meaning of the rolls includes that of rotors.

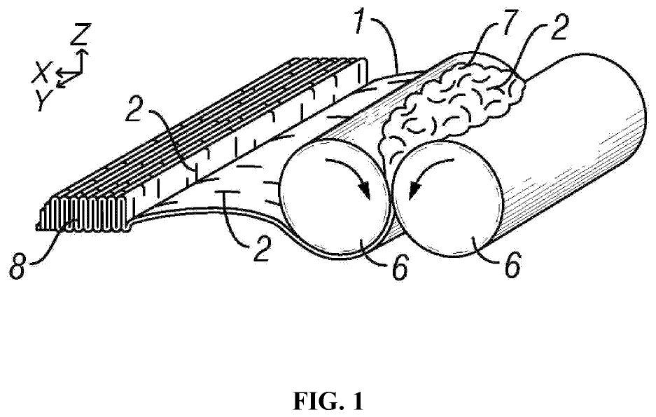

FIG. 1 illustrates the crumb rubber particles which are substantially perpendicularly oriented to the discharge direction (X) and the axial direction (Y) and which are substantially parallelly oriented to the other direction (Z). The rollers (6) on the calendar produces the calendered rubber layer (1) from the rubber composition (2) fed into the roller (6). The crumb rubber particles (2) are substantially parallelly aligned in the discharge direction (X) just after producing the calendered rubber layer (1). However, by repeatedly folding (8) the calendered rubber layer (1), the crumb rubber particles (2) are almost aligned in the other direction (Z). The top and the bottom zones including the folded end points are preferably cut and excluded because some of the crumb rubber particles (2) in the zones may not be aligned in the other direction (Z).

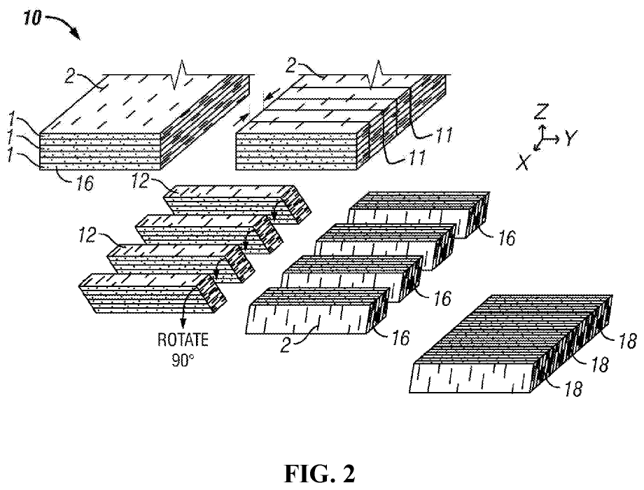

FIG. 2 also illustrates the crumb rubber particles which are substantially perpendicularly oriented to the discharge direction (X) and the axial direction (Y) and which are substantially parallelly oriented to the other direction (Z). A stack (10) of calendered rubber layers (1) is cut (11) at sections substantially perpendicular to the discharge direction (X). Each of the cut sections (12) are separated and then substantially rotated from the other direction (Z) to the discharge direction (X). The rotated sections (16) then have the crumb rubber particles (2) contained therein substantially perpendicularly oriented to the discharge direction (X) and the axial direction (Y) and substantially parallelly oriented to the other direction (Z). The sections (16) may then be bonded together at a seam (18).

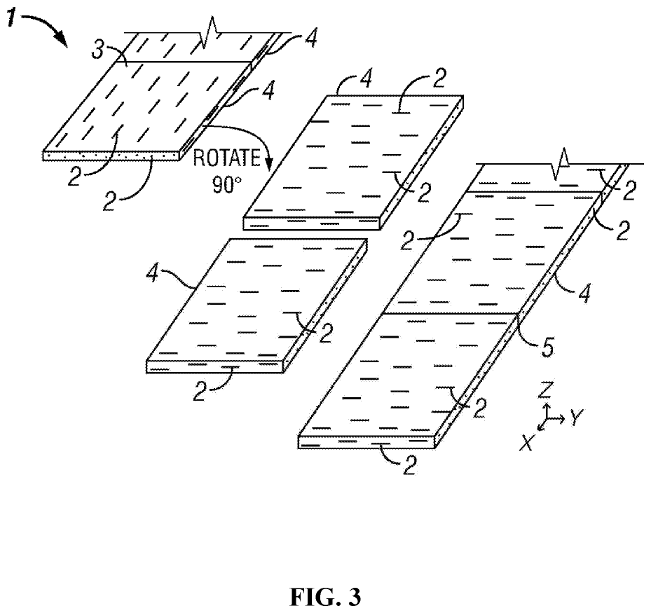

FIG. 3 illustrates the crumb rubber particles which are substantially perpendicularly oriented to the discharge direction (X) and the other direction (Z) and which are substantially parallelly oriented to the axial direction (Y). A rubber layer (1) is produced through a roller process that substantially orients the crumb rubber particles (2) in the discharge direction (X), then the rubber layer (1) is cut (3) into sections (4) that are then substantially rotated from the axial direction (Y) to the discharge direction (X) so that the crumb rubber particles (2) are substantially parallelly oriented to the axial direction (Y). The sections (4) may then be bonded together at a seam (5). A plurality of rubber layers (1) may be stacked to provide a desired thickness of the rubber composition comprising the crumb rubber having the crumb rubber particles oriented unidirectionally.

An eleventh aspect of the invention is the rubber sheet according to the tenth aspect, wherein the rolls have at least one roll nip of less than 5.0 mm. The roll nip is a distance of a gap between the rolls. The thinner the roll nip, the thinner the rubber layer and the better the unidirectional orientation of the crumb rubber particles.

According to a preferred embodiment of the eleventh aspect, the roll nip is less than 4.5 mm, more preferably less than 4.0 mm, still more preferably less than 3.5 mm, particularly less than 3.0 mm, more particularly less than 2.5 mm, still more particularly less than or equivalent to 2.0 mm.

According to a preferred embodiment of the eleventh aspect, the roll nip is more than 0.5 mm.

The crosslinking (or curing) may be performed in a known manner at a temperature of more than 110° C. and less than 200° C., preferably more than 130° C. and less than 190° C., under pressure, for a sufficient time which may range, for example, between 5 and 90 mm, as a function notably of the curing temperature, of the crosslinking system adopted, of the kinetics of crosslinking of the rubber composition of the rubber sheet according to the invention under consideration or else of a size of a part for a rubber product.

The rubber sheet according to the invention may be used for various rubber parts such as a tread (for example, a cap-tread, a sub-tread, an under-tread), a sidewall, a rim cushion (as known as a chafer), a sidewall reinforcement, a belt skim (as known as a wire skim), a belt cushion, an inner liner, a bead, a bead filler (as known as an apex), any compound used in a carcass (a carcass topping) and other components for vehicle tires, a sole (for example, an outsole, a midsole and an insole) for shoes, a tread, a pad, for rubber tracks (the rubber tracks each is one of continuous tracks, also called as rubber crawler or rubber track belt or rubber caterpillar track and intended to equip a tracked vehicle), industrial rubber products (for example, anti-vibration mounts, conveyor belts, timing belts, power transmission belts, hoses, flooring (including walk-off mats and stair treads), gaskets, molded mechanical parts, seals (for example, oil-field products automotive seals, weather stripping seals) and Recylate in TPV's (TPV: thermoplastic vulcanizate) for sustainability and performance) and other rubber goods.

A twelfth aspect of the invention is a rubber laminate having a plurality of the rubber sheets according to any one of the first to the eleventh aspects, preferably wherein the crumb rubber particles in each of the rubber sheets is substantially parallelly oriented to crumb rubber particles in an adjacent rubber sheet according to any one of the first to the eleventh aspects.

A thirteenth aspect of the invention is a rubber part including a rubber sheet according to any one of the first to the eleventh aspects, or a rubber laminate according to the twelfth aspect, preferably wherein the rubber part is a tire tread, a tire sidewall, a tire rim cushion, a tire sidewall reinforcement, a tire belt skim, a tire belt cushion, a tire inner liner, a tire bead filler, a tire carcass topping, a shoe sole, a rubber track tread, a rubber track pad, an anti-vibration mount, a conveyor belt, a timing belt, a power transmission belt, a hose, a flooring, a gasket, a molded mechanical part, a seal or recyclate in thermoplastic vulcanizate.

A fourteenth aspect of the invention is a rubber product comprising a rubber part according to the thirteenth aspect, preferably wherein the rubber product is a tire, a shoe, a rubber track or an industrial rubber product.

A fifteenth aspect of the invention is the rubber product according to the fourteenth aspect, wherein the crumb rubber particles are substantially perpendicularly oriented to a direction of strain expected to be applied to the rubber sheet of the rubber part during the use of the rubber product.

The invention is further illustrated by the following non-limiting examples.

In order to confirm the effect of the invention, two samples (Sample 1: A control and Sample 2: An example according to the invention) as rubber sheets made of a rubber composition were used. The rubber composition is based on diene elastomers (a combination of natural rubber (abbreviated as “NR”) and polybutadiene rubber (abbreviated as “BR”) as an elastomer matrix) reinforced with a carbon black (as a reinforcing filler), a plasticizing agent (a combination of an oil (naphthenic oil) and a hydrocarbon resin (C₅ resin)) with or without a crumb rubber. The formulation of the rubber composition is shown in Table 1 with the amount of the various products expressed in phr.

TABLE 1

| Rubber composition | (phr) |
|---|---|
| NR (1) | 50 |
| BR (2) | 50 |
| Carbon black (3) | 56 |
| Plasticizing agent (4) | 17.5 |
| Crumb rubber (5) | 82.7 |
| Protection agent/Processing aid (6) | 11.5 |
| Crosslinking system (7) | 6.4 |

(1) Natural rubber;
(2) Nd Butadiene rubber;
(3) Carbon black (ASTM grade N330 from Cabot, BET (in accordance with ASTM D6556-10): 75 m²/g, COAN (in accordance with ASTM D3493-16): 88 ml/100 g);
(4) Combination of a liquid plasticizer (Naphthalic oil (“Hyprene L2000” from Ergon)) and a hydrocarbon resin (C₅ Resin (“Escorez 1102” from Exxon));
(5) Crumb rubber (combination of less than 10% by weight of 80 mesh sieve residue and equal to or more than 80% by weight of 140 mesh sieve residue per 100% by weight of all of the crumb rubber and the particle size measured according to ASTM D5644-01);
(6) Combination of protection agent (combination of antioxidant (combination of N-(1,3-dimethylbutyl)-N-phenyl-para-phenylenediamine (“Santoflex 6-PPD” from Flexsys) and 2,2,4-trimethyl-1,2-dihydroquinolone (“TMQ” from Lanxess)) and anti-ozone wax (“Varazon 6500” from Sasol)) and processing aid (“Struktol 40MS” from Struktol); and
(7) Combination of stearic acid (“Pristerene 4931” from Uniqema), zinc oxide (industrial grade from Umicore company), N-dicyclohexyl-2-benzothiazolesulfenamide (“Santocure CBS” from Flexsys), N-cyclohexylthiophthalimide (“Vulkalent G” from Lanxess) and soluble sulfur.

The rubber composition was produced as follows: The reinforcing filler, the elastomer matrix, the plasticizing agent and the various other ingredients, with the exception of sulfur (as a vulcanization agent), N-Cyclohexyl-2-benzothiazolesulfenamide (abbreviated as “CBS”) (as a vulcanization accelerator) and vulcanization retarder (N-cyclohexylthiophthalimide (abbreviated as “CTP”) in a crosslinking system, were successively introduced into an internal mixer having an initial vessel temperature of approximately 60° C.; the mixer was thus approximately 70% full (% by volume). The crumb rubber was introduced into the internal mixer when the vessel temperature hits 90° C. Thermomechanical working (non-productive phase) was then carried out in one stage, which lasts in total approximately 3 minutes to 4 minutes, until a maximum “dropping” temperature of 160° C. was reached. The mixture thus obtained was recovered and cooled and then the vulcanization agent, the vulcanization accelerator and the vulcanization retarder in the crosslinking system were incorporated on an open mill (homofinisher) at 20° C. to 30° C., everything being mixed (productive phase) for an appropriate time (for example, more than 5 minutes and less than 12 minutes).

Sample 1 according to the invention was produced by subsequently calendaring the above obtained rubber composition in accordance with a method shown in FIG. 3 without the rotation.

Sample 2 as the control was produced by subsequently calendaring the above obtained rubber composition in accordance with a method shown in FIG. 3. The number of the crumb rubber particles substantially perpendicularly oriented to the longitudinal direction of the Sample 2 was 2.1 times of the number of the other crumb rubber particles not substantially perpendicularly oriented to the longitudinal direction of the Sample 2.

The roll nip during the calendaring process was within the range of from 1.0 mm to 2.0 mm.

The fatigue strength performance of all Samples was measured in accordance with the following method: 12 test specimens for each of all Samples were prepared by curing at 150° C. for 25 minutes in a bell press. The fatigue strength, expressed as number of cycles or in relative units (r.u.), was measured in a known manner on 12 test specimens subjected to repeated low-frequency tensile deformations up to an elongation of 75%, at 23° C., using a Monsanto (FTF: Fatigue to Failure) machine until the test specimen breaks, according to the ASTM D4482-85 and ISO 6943 standards. The direction of the elongation was along the longitudinal direction of each of Samples 1 and 2. The result shown in Table 2 is expressed in relative units (r.u.). A value greater than that of Sample 1, arbitrarily set at 100, indicates an improved result, that is to say a better fatigue strength of the rubber samples.

The results from Table 2 demonstrate that the Sample 2 according to the invention has better values of the fatigue strength than that of Sample 1 as the control.

TABLE 2

| | Control | Example |
|---|---|---|
| Rubber sheet | Sample 1 | Sample 2 |
| Fatigue strength | 100 | 114 |

In conclusion, the rubber sheet according to the invention allows unexpectedly improved fatigue strength.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

As used herein, the term “method” or “process” refers to one or more steps that may be performed in other ordering than shown without departing from the scope of the presently disclosed invention. As used herein, the term “method” or “process” may include one or more steps performed at least by one electronic or computer-based apparatus. Any sequence of steps is exemplary and is not intended to limit methods described herein to any particular sequence, nor is it intended to preclude adding steps, omitting steps, repeating steps, or performing steps simultaneously. As used herein, the term “method” or “process” may include one or more steps performed at least by one electronic or computer-based apparatus having a processor for executing instructions that carry out the steps.

As used herein, the terms “a”, “an”, and the singular forms of words shall be taken to include the plural form of the same words, such that the terms mean that one or more of something is provided.

As used herein, the terms “at least one” and “one or more” are used interchangeably.

As used herein, the term “one” or “single” shall be used to indicate that one and only one of something is intended. Similarly, other specific integer values, such as “two”, are used when a specific number of things is intended.

As used herein, any interval of values denoted by the expression “between a and b” represents the range of values of more than “a” and of less than “b” (i.e. the limits a and b excluded) whereas any interval of values denoted by the expression “from a to b” means the range of values going from “a” to “b” (i.e. including the strict limits a and b).

As used herein, the terms “preferably”, “preferred”, “prefer”, “particularly”, “particular”, “advantageously”, “especially”, “specially”, “optionally”, “may”, and similar terms are used to indicate that an item, condition or step being referred to is an optional (not required) feature of the invention.

As used herein, the terms “comprising”, “including”, and “having” shall be considered as indicating an open group that may include other elements not specified.

As used herein, the term “consisting essentially of” shall be considered as indicating a partially open group that may include other elements not specified, so long as those other elements do not materially alter the basic and novel characteristics of the claimed invention.

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A rubber sheet made of a rubber composition based on at least an elastomer matrix and a crumb rubber comprising crumb rubber particles substantially perpendicularly oriented to a longitudinal direction of the rubber sheet.

2. The rubber sheet according to claim 1, wherein the elastomer matrix comprises at least one elastomer selected from the group consisting of an isoprene elastomer and a butadiene elastomer.

3. The rubber sheet according to claim 1, wherein the crumb rubber particles do not remain on a 40 mesh sieve, or the crumb rubber particles remain on a 40 mesh sieve and the total amount of the crumb rubber particles remaining on the 40 mesh sieve is less than 10% by weight per 100% by weight of the crumb rubber.

4. The rubber sheet according to claim 3, wherein the total amount of the crumb rubber is within the range of from 5 phr to 200 phr.

5. The rubber sheet according to claim 3, wherein the crumb rubber has not undergone any modification by a treatment selected from the group consisting of thermal, mechanical, biological, and chemical treatments and combinations thereof.

6. The rubber sheet according to claim 5, wherein the rubber composition is further based on a reinforcing filler.

7. The rubber sheet according to claim 6, wherein the rubber composition is further based on a plasticizing agent.

8. The rubber sheet according to claim 7, wherein the rubber composition is further based on a crosslinking system.

9. The rubber sheet according to claim 1, wherein the rubber sheet according to the invention has a length in the longitudinal direction, a width in a lateral direction and a thickness in a vertical direction, wherein the length is longer than the width, wherein the width is longer than the thickness, wherein the longitudinal direction is perpendicular to the lateral direction and the vertical direction, wherein the lateral direction is perpendicular to the vertical direction, and wherein the crumb rubber particles are further substantially parallelly oriented to the lateral direction or the vertical direction.

10. The rubber sheet according to claim 1, wherein the rubber sheet is produced by a method comprising at least:
a step of feeding the rubber composition into a roller process having a plural of rolls having a rotation axle with an axial direction (Y);
a step of discharging a discharged rubber layer made of the rubber composition from the roll process in a discharge direction (X) which is perpendicular to the axial direction (Y) and which is perpendicular to another direction (Z) perpendicular to the axial direction (Y);
wherein the method further comprises:
a step of repeatedly folding the discharged rubber layer in a direction substantially parallel to the other direction (Z);
or
wherein the method further comprises:
a step of stacking a plural of the discharged rubber layers or not stacking; and
a step of cutting the discharged rubber layer or the plural of the discharged rubber layers into sections substantially perpendicular to the discharge direction (X);
a step of rotating the normal direction of the cut sections to a direction substantially parallel to the axial direction (Y) or the other direction (Z); and
a step of bonding the rotated sections together at a seam.

11. The rubber sheet according to claim 10, wherein the rolls have at least one roll nip of less than 5.0 mm.

12. A rubber laminate having a plurality of the rubber sheets according to claim 11.

13. A rubber part including a rubber sheet according to claim 11 wherein the rubber part is a tire tread, a tire sidewall, a tire rim cushion, a tire sidewall reinforcement, a tire belt skim, a tire belt cushion, a tire inner liner, a tire bead filler, a tire carcass topping, a shoe sole, a rubber track tread, a rubber track pad, an anti-vibration mount, a conveyor belt, a timing belt, a power transmission belt, a hose, a flooring, a gasket, a molded mechanical part, a seal or recyclate in thermoplastic vulcanizate.

14. A rubber product comprising a rubber part according to claim 13, preferably wherein the rubber product is a tire, a shoe, a rubber track or an industrial rubber product.

15. The rubber product according to claim 14, wherein the crumb rubber particles are substantially perpendicularly oriented to a direction of strain expected to be applied to the rubber sheet of the rubber part during the use of the rubber product.

16. The rubber sheet according to claim 1, wherein the crumb rubber particles do not remain on a 60 mesh sieve, or the crumb rubber comprises crumb rubber particles remaining on a 60 mesh sieve and the total amount of the crumb rubber particles remaining on the 60 mesh sieve is less than 10% by weight per 100% by weight of the crumb rubber.

17. The rubber sheet according to claim 1, wherein the crumb rubber particles do not remain on a 80 mesh sieve, or the crumb rubber comprises crumb rubber particles remaining on a 80 mesh sieve and the total amount of the crumb rubber particles remaining on the 80 mesh sieve is less than 10% by weight per 100% by weight of the crumb rubber.

18. The rubber laminate according to claim 12 wherein the crumb rubber particles in each of the rubber sheets is substantially parallelly oriented to crumb rubber particles in an adjacent rubber sheet.

19. A rubber part including a rubber laminate according to claim 12 wherein the rubber part is a tire tread, a tire sidewall, a tire rim cushion, a tire sidewall reinforcement, a tire belt skim, a tire belt cushion, a tire inner liner, a tire bead filler, a tire carcass topping, a shoe sole, a rubber track tread, a rubber track pad, an anti-vibration mount, a conveyor belt, a timing belt, a power transmission belt, a hose, a flooring, a gasket, a molded mechanical part, a seal or recyclate in thermoplastic vulcanizate.
